(19) United States
(12) Patent Application Publication
(10) Pub. No.: US 2002/0162369 A1
(43) Pub. Date: Nov. 7, 2002

(54) Cable actuation and locking system

(76) Inventors: Alan E. Lurie, Huntington, NY (US); Hans E. R. Bosch, Lloyd Neck, NY (US)

Correspondence Address: Christopher G. Trainor, CARTER, DELUCA, FARRELL & SCHMIDT, LLP, Suite 225, 445 Broad Hollow Road, Melville, NY, 11747, US

(21) Appl. No.: 10/103,179

(22) Filed: Mar. 20, 2002

Related U.S. Application Data
(60) Provisional application No. 60/277,208, filed on Mar. 20, 2001.

(51) Int. Cl. E05B 65/12

(52) U.S. Cl. 70/256

(57) ABSTRACT

A cable actuation and locking system is provided for operating a plurality of locking devices simultaneously using a single activation device. The cable actuation and locking system includes a lock actuator having an actuation member which is movable between first and second positions, at least one locking device having a movable bolt, a cable assembly interconnecting the actuation member to the bolt, and an activation device which is operatively connected to the actuation member. The activation device is operable to move the actuation member between the first and second positions to move the bolt between locked and unlocked positions. A plurality of locking devices may be provided and interconnected with the actuation member such that operation of the activation device will effect the operation of multiple locking devices simultaneously. In one preferred embodiment, the activation device comprises a key operated rotatable lock core and the device comprises a rotatable plate. A plurality of locking devices are provided and each is connected to the actuation member by a cable assembly. In another preferred embodiment, the activation device includes a motor assembly which drives a screw to move an actuation member between first and second positions.

### BACKGROUND

This application claims priority from U.S. provisional patent application Serial No. 60/277,208, filed Mar. 20, 2001, the entirety of which is incorporated herein by reference.

1. Technical Field

The present disclosure relates generally to an apparatus for actuating one or more locking assemblies simultaneously with a single operating member. More particularly, the present disclosure relates to an actuation and locking system for locking and unlocking multiple cabinet doors, drawers, etc., simultaneously using a single activation member.

2. Background to Related Art

Locking devices for locking cabinet doors, drawers, etc., of a display case, are well known. Typically, such devices include a spring biased latch which can be locked or unlocked using a rotatable key. In a store or other location where a multiplicity of cabinets are located, it may be necessary for each individual cabinet to be manually unlocked and locked every day. Depending on the number of cabinets, this may require a lot of time and effort on the part of the shopkeeper.

Accordingly, a need exists for an actuation and locking system which can be operated to actuate multiple locking assemblies using a single operating member.

### SUMMARY

In accordance with the present disclosure, a cable actuation and locking system is provided for operating a plurality of locking devices simultaneously using a single activation device. The cable actuation and locking system includes a lock actuator having an actuation member which is movable between first and second positions, at least one locking device having a movable bolt, a cable assembly interconnecting the actuation member to the bolt, and an activation device which is operatively connected to the actuation member. The activation device is operable to move the actuation member between the first and second positions to move the bolt between locked and unlocked positions. A plurality of locking devices may be provided and interconnected with the actuation member such that operation of the activation device will effect the operation of multiple locking devices simultaneously.

In one preferred embodiment, the activation device comprises a key operated rotatable lock core and the actuation device comprises a rotatable plate. A plurality of locking devices are provided and each is connected to the actuation member by a cable assembly. In another preferred embodiment, the activation device includes a motor assembly which drives a screw to move an actuation member between first and second positions.

### BRIEF DESCRIPTION OF THE DRAWINGS

Various preferred embodiments of the presently disclosed cable actuation and locking system are disclosed herein with reference to the drawings, wherein:

FIG. 1 illustrates a top plan view of one embodiment of the presently disclosed cable actuation and locking system;

FIG. 2 illustrates a side elevational view of a portion of the lock actuator of the cable actuation and locking system illustrated in FIG. 1;

FIG. 3 illustrates a side view of the lock core assembly of the lock actuator of the cable actuation and locking system illustrated in FIG. 2;

FIG. 4 illustrates a top perspective view of another preferred embodiment of the presently disclosed cable actuation and locking system;

FIG. 5 illustrates a side perspective view of the cable actuation and locking system illustrated in FIG. 4;

FIG. 6 illustrates an opposite side perspective view of the cable actuation and locking system illustrated in FIG. 5;

FIG. 7 illustrates a side perspective view of the locking member of the cable actuation and locking system illustrated in FIG. 5;

FIG. 8 illustrates a side perspective partial cutaway schematic view of the presently disclosed cable actuation and locking system mounted within a cabinet.

### DETAILED DESCRIPTION OF PREFERRED EMBODIMENTS

Preferred embodiments of the presently disclosed cable actuation and locking system will now be described in detail when reference to the drawings in which like reference numerals designate identical or corresponding elements in each of the several views.

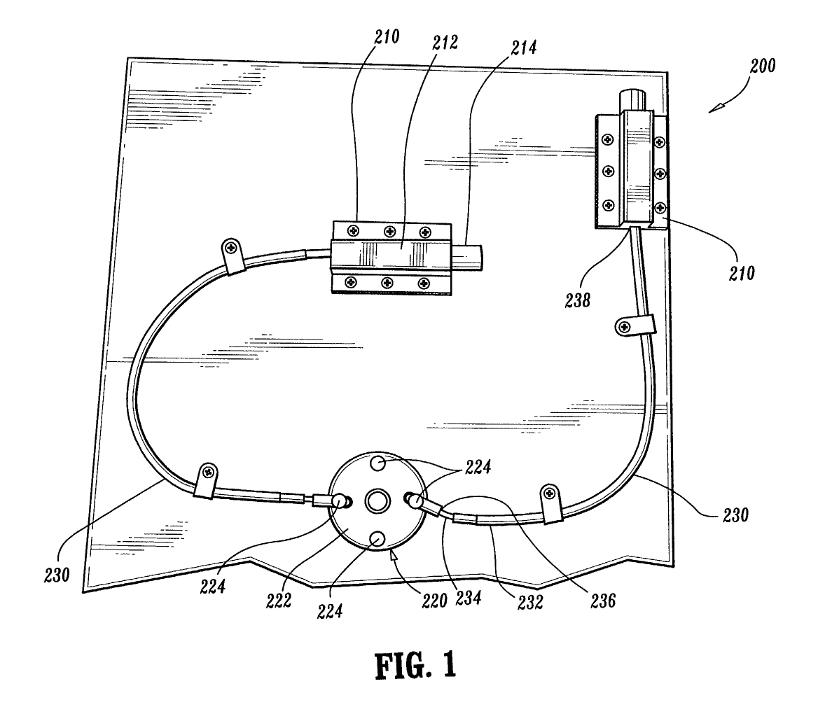

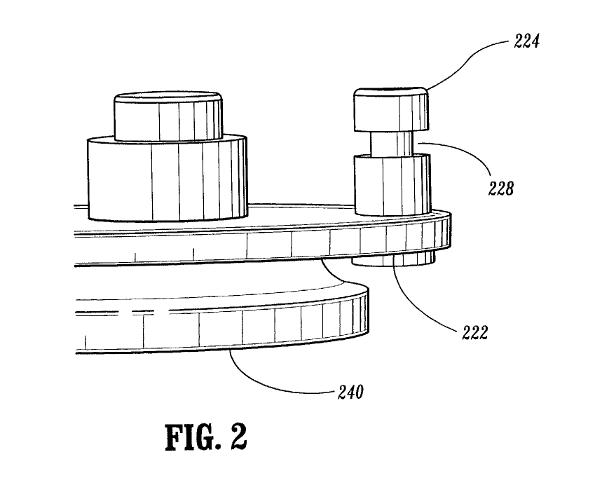

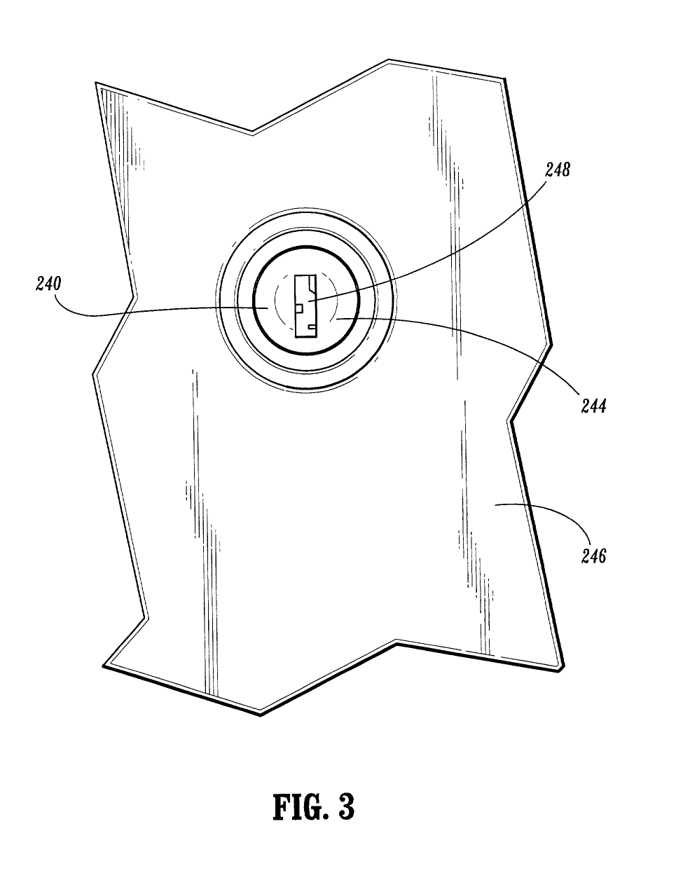

FIGS. 1-3 illustrate one preferred embodiment of the presently disclosed cable actuation and locking system shown generally as 200. System 200 includes at least one locking device or assembly 210, a lock actuator 220 and a link or cable assembly 230. Each locking device 210 includes a housing 212 and a bolt or latch member 214 slidably positioned within housing 212. Latch member 214, although illustrated as being a dead bolt, may also be a spring biased latch member such as a standard door latch.

Cable assembly 230 includes a fixed outer sheath 232 and an inner reciprocatable wire 234. Wire 234 has a first end 236 connected to lock actuator 220 and a second end 238 connected to latch member 214 of locking device 210. A coupling member (not shown) may be provided to operably connect wire 234 to latch member 214.

In one preferred embodiment, actuator 220 includes a rotatable actuation plate 222 having a multiplicity of connectors or posts 224 supported on a top surface 226 thereof. Although four posts are shown, any number of posts may be provided to accommodate any number of locking members. Each post 224 is rotatably fixed to plate 222 and includes an annular recess 228 for receiving first end 236 of wire 234. A bottom of plate 222 is secured to an activation device or rotatable lock core assembly 240 by a center screw 242. Alternately, other fastening techniques may be employed to secure plate 222 to lock core assembly 240. Lock core assembly 240 includes a rotatable core 244 which extends through a cabinet door 246 and includes a key slot 248.

In use, when a key (not shown) is inserted into key slot 248 and rotated, plate 222 is also rotated. When plate 222 is rotated, wire 234 is either retracted or advanced within sheath 232 to effect retraction or advancement of latch member 214. Because a multiplicity of cable assemblies 230 can be attached to a single plate 222 via posts 224, cable actuation and locking system 200 can be used to operate a multiplicity of locking assemblies using a single activation member, i.e., a key. It is also noted that it is envisioned that system 200 may be used with structure other than cabinets including all doors, windows, etc.

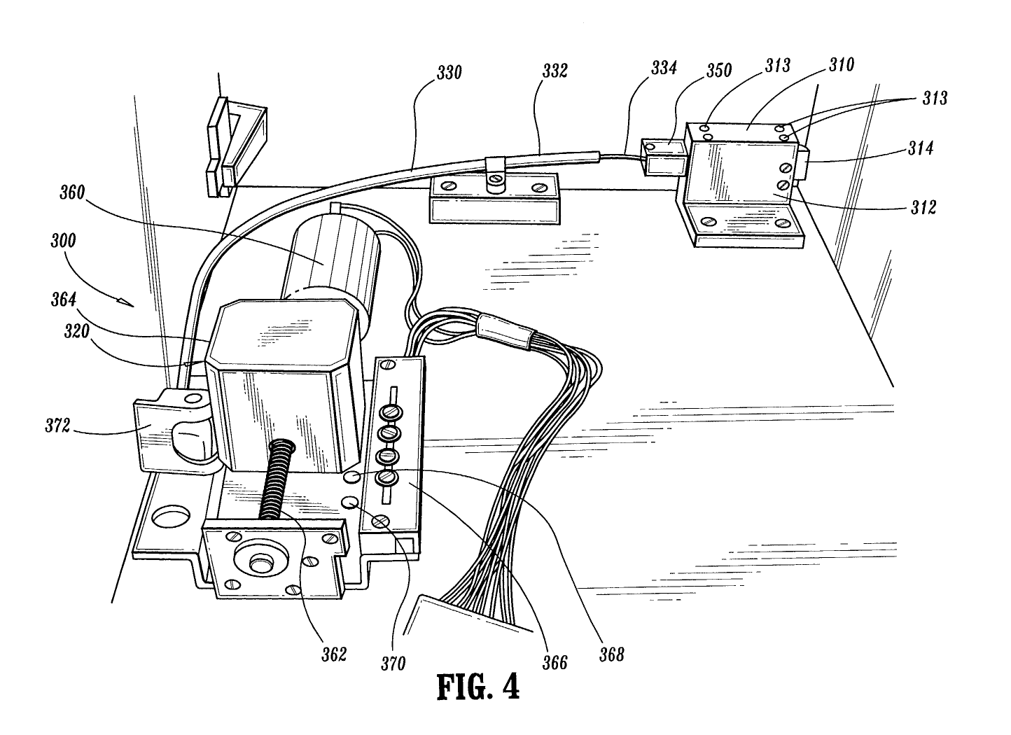

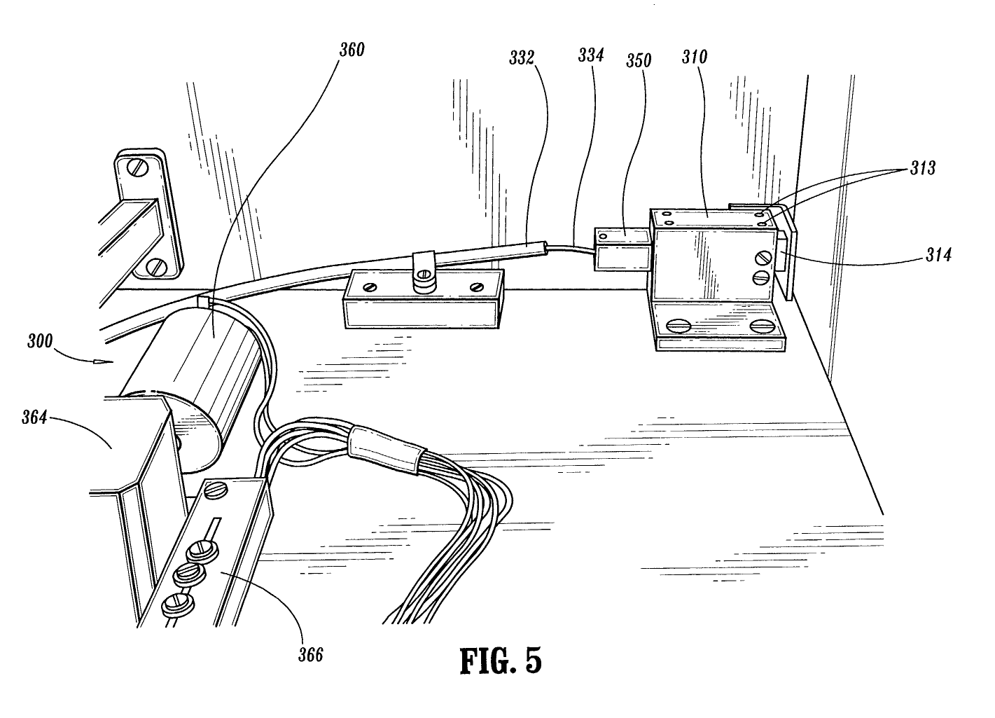

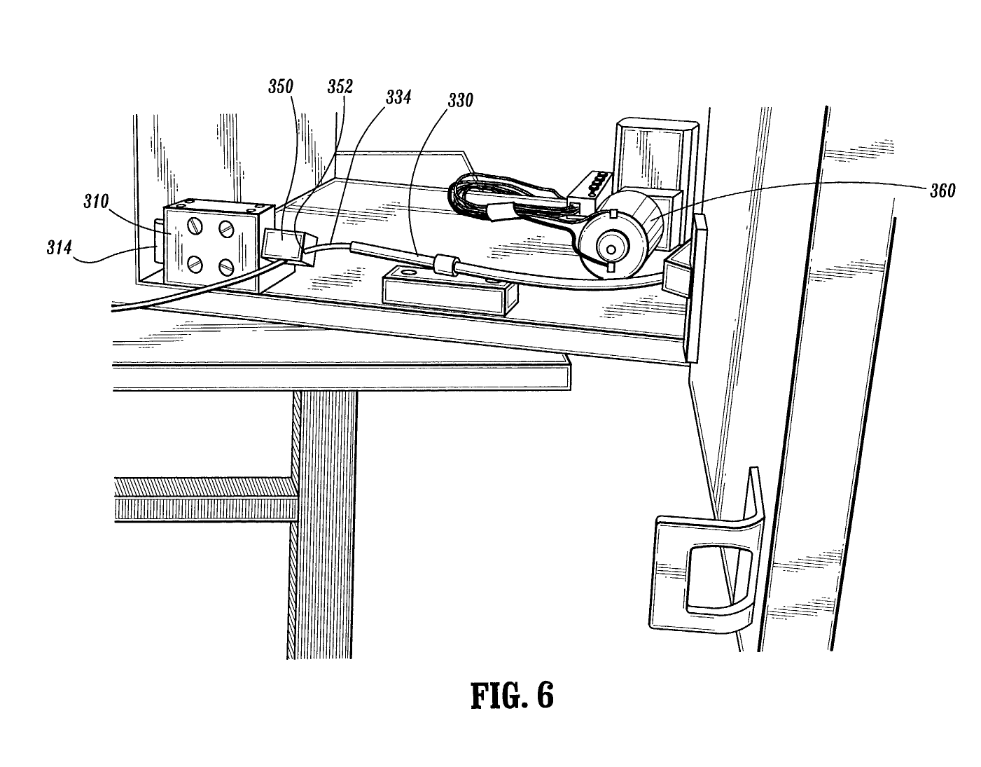

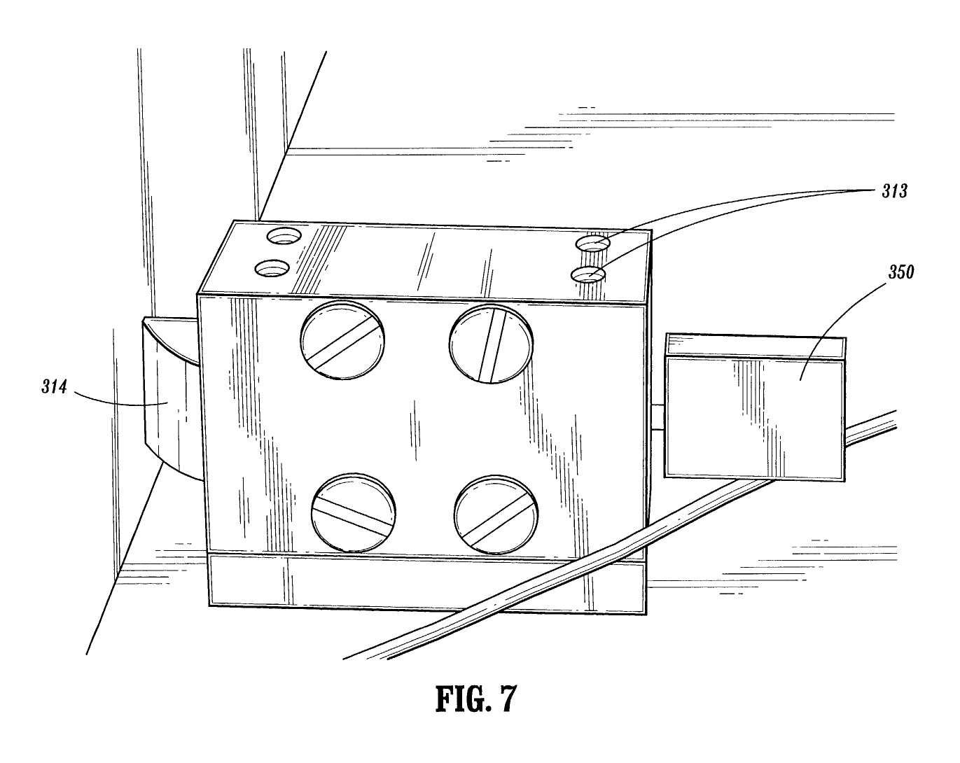

FIGS. 4-7 illustrate a second preferred embodiment of the presently disclosed cable actuation system shown generally as 300. System 300 also includes at least one locking member 310, a lock actuator 320 and a cable assembly 330. Cable assembly 330 and locking member 310 are substantially the same as cable assembly 230 and locking member 210 with a few exceptions which will now be discussed. Locking member 310 includes a housing 312 which includes mounting bores 313 formed in the top of housing 312. Mounting bores 313 allow housing 312 to be flipped over and used on an opposite side of a cabinet or structure, i.e., housing 312 is reversible. A coupling member 350 is secured to the proximal end of latch member 314. Coupling member 350 may be molded about latch member 314 or attached thereto using any known fastening technique. Coupling member 350 includes a throughbore 352 for receiving the second end 338 of wire 334 to secure wire 334 to latch member 314.

Actuator 320 includes an activation device or motor 360 which drives a screw 362. Screw 362 extends through an actuator member 364 which is rotatably fixed but free to move linearly. As screw 362 is driven by motor 360, actuator member 364 is moved linearly along screw 362. A limit switch assembly 366 including first and second contacts 368 and 370 is positioned adjacent a first side of actuator member 364 to control operation of motor 360.

A wire connector 372 is secured to second side of actuator member 364 using any known fastening technique, e.g., screws, welding, etc. A first end 336 of wire 334 is secured to connector 372 such that movement of actuator member 364 effects reciprocation of wire 334 within sheath 332 to actuate latch member 314. It is noted that multiple cable assemblies can be secured to connector 372 such that actuator 320 can be used to actuate multiple locking members 310 simultaneously.

Actuator 320 can be designed to be manually operated using a push button electrically connected to the motor or remotely operated using a wireless transmitter and receiver to actuate the motor. The wireless transmitter may be of any known type including RF, infrared, etc.

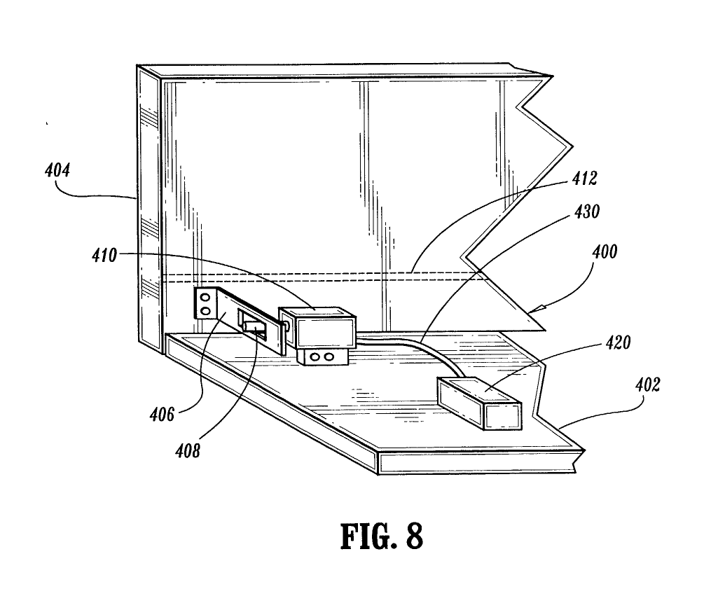

FIG. 8 illustrates a schematic representation of a cable actuation and lock system supported within a cabinet 400. Cabinet 400 includes a frame 402 and a door 404. A catch 406 is secured to door 404 and is configured to engage bolt 408. Actuator 420, cable assembly 430, and locking device 410 are supported within a cabinet 400. A motor (not shown) may also be provided to drive actuator 420. The entire assembly may be enclosed in a separate compartment within cabinet defined by panel 412. Alternately, the actuator 420 and cable assembly 430 can be located externally of cabinet 400.

It will be understood that various modifications may be made to the embodiments disclosed herein. For example, the actuator member 364 need not be block shaped but rather may assume a variety of configurations including a notched bar including slots for directly connecting to wire 334. Moreover, the components can be formed of any material having the requisite strength requirements including metals, plastics, etc. Therefore, the above description should not be construed as limiting, but merely as exemplifications of preferred embodiments. Those skilled in the art will envision other modifications within the scope and spirit of the claims appended hereto.

What is claimed:

1. An actuation and locking system comprising:
a lock actuator including an actuation member which is movable between first and second positions;
at least one locking device including a housing and a bolt movable supported within the housing between locked and unlocked positions;
a cable assembly interconnecting the actuation member to the bolt; and
an activation device operatively connected to the lock actuator and being operable to move the actuation member between the first and second positions, wherein movement of the actuation member between the first and second positions is translated by the cable assembly into movement of the bolt of the locking device between the unlocked and locked positions.

2. An actuation and locking system according to claim 1, wherein the activation device includes a rotatable lock core assembly which is operatively connected to the actuation member.

3. An actuation and locking system according to claim 2, wherein the actuation member includes a rotatable plate.

4. An actuation and locking system according to claim 3, wherein the rotatable lock core assembly includes a key operated rotatable core which is connected to the rotatable plate of the lock actuator, the key operated rotatable core being rotatable to effect rotation of the rotatable plate of the lock actuator.

5. An actuation and locking system according to claim 1, wherein the at east one locking device includes a plurality of locking devices, each locking device having one said bolt, each of the bolts being operatively connected to the actuation member by one said cable assembly, wherein movement of the actuation member between the first and second positions effects simultaneous movement of each of the bolts between the locked and unlocked positions.

6. An actuation and locking system according to claim 5, wherein the actuation member includes a rotatable plate.

7. An actuation and locking system according to claim 6, further including a plurality of connectors secured to the rotatable plate, each connector being connected to a respective one of the cable assemblies.

8. An actuation and locking system according to claim 7, wherein each cable assembly includes a fixed outer sheath and an inner reciprocable wire, the reciprocable wire having one end operatively connected to the actuation member and a second end operatively connected to a respective bolt.

9. An actuation and locking system according to claim 1, wherein each cable assembly includes a fixed outer sheath and an inner reciprocable wire, the reciprocable wire having one end operatively connected to the actuation member and a second end operatively connected to a respective bolt.

10. An actuation and locking system according to claim 1, wherein the activation device includes a motor, the motor being operable to move the actuation member between the first and second positions.

11. An actuation and locking system according to claim 10, further including a screw driven by the motor, the screw being operatively engaged with the actuation member, the motor being operable to effect linear advancement of the actuation member.

12. An actuation and locking system according to claim 10, wherein the at least one locking device includes a plurality of locking devices, each locking device having one said bolt, each of the bolts being operatively connected to the actuation member by one said cable assembly, wherein movement of the actuation member between the first and second positions effects simultaneous movement of each of the bolts between the locked and unlocked positions.

13. An actuation and locking system according to claim 10, wherein the motor is remotely actuable via a wireless transmitter.

14. An actuation and locking system according to claim 1, wherein the bolt includes a dead bolt.

15. An actuation and locking system according to claim 1, wherein the bolt includes a spring biased latch member.

16. An actuation and locking system for simultaneously operating a plurality of locking devices, the system comprising:
a lock actuator including an actuation member which is movable between first and second positions;
a plurality of locking devices, each locking device including a bolt which is movable between locked and unlocked positions;
a plurality of link members each link member interconnecting a respective bolt to the actuation member; and
an activation device operatively connected to the lock actuator and being operable to move the actuation member between the first and second positions, wherein movement of the actuation member between the first and second positions effects movement of the plurality of links to effect movement of each the bolts of the locking devices between the unlocked and locked positions.

17. An actuation and locking system according to claim 16, wherein the activation device includes a rotatable lock core assembly which is operatively connected to the actuation member.

18. An actuation and locking system according to claim 10, wherein the activation device includes a motor, the motor being operable to move the actuation member between the first and second positions.
